(19) United States
(12) Patent Application Publication
(10) Pub. No.: US 2025/0389081 A1
(43) Pub. Date: Dec. 25, 2025

(54) Treatment Liquid Composition For Dye Printing, Ink Set, And Recording Method

(71) Applicant: SEIKO EPSON CORPORATION, Tokyo (JP)

(72) Inventors: Yuki WAKUSHIMA, Milano (IT); Yoshitaka MIYAJIMA, Matsumoto (JP); Angelo MARELLI, Cantu (IT); Ugo ZAROLI, Busto Arsizio (IT); Francesco TIBILETTI, Varese (IT); Nicola FEOLA, Como (IT)

(21) Appl. No.: 19/245,808

(22) Filed: Jun. 23, 2025

(30) Foreign Application Priority Data
Jun. 24, 2024 (JP) 2024-101213

(51) Int. Cl. D06P 5/00; B41J 3/407; B41M 5/00; D06P 5/30

(52) U.S. Cl. CPC D06P 5/002; B41J 3/4078; B41M 5/0017; D06P 5/30; D10B 2211/02; D10B 2211/04; D10B 2331/02

(57) ABSTRACT

To provide a printed matter that has excellent fixing property and color developing property, suppresses color unevenness, and is obtained by reducing the total content of nitride at the time of draining. A treatment liquid composition for dye printing contains one or more types of sugars selected from lactose, sucrose, trehalose, and sorbitol, a polymer compound, and a pH adjusting agent, in which a pH is 7.0 or less and a viscosity is 2.0 mPa·s or more and 20,000 mPa·s or less.

The present application is based on, and claims priority from JP Application Serial Number 2024-101213, filed Jun. 24, 2024, the disclosure of which is hereby incorporated by reference herein in its entirety.

### BACKGROUND

### 1. Technical Field

The present disclosure relates to a treatment liquid composition for dye printing, an ink set, and a recording method.

### 2. Related Art

Ink jet recording methods can record high-definition images with a relatively simple apparatus and are rapidly developed in various fields. For example, JP-A-2024-25269 discloses an aqueous functional ink for ink jet textile printing, which is used in combination with a recording ink containing a reactive dye and contains a moisturizer and an alkaline agent, and in which a content of a sizing agent is 0% by mass or more and 1% by mass or less, and a pH (potential of hydrogen) is 10 or less, with an object of providing a functional ink for ink jet printing which is able to improve durability of an ink jet head and ensure a color developing property of a recording ink.

### SUMMARY

In a textile printing technology, a pretreatment is performed on a recording medium such as a fabric to prevent a recording ink from bleeding and to improve a fixing property of the ink that has landed on the recording medium. In such a pretreatment liquid, urea is used from the viewpoint of improving the fixing property and a color developing property, but a waste liquid containing urea is generated when washing a printed matter, and thus environmental adaptability is concerned.

A treatment liquid composition for dye printing of the present disclosure contains one or more types of sugars selected from lactose, sucrose, trehalose, and sorbitol, a polymer compound, and a pH adjusting agent, in which a pH is 7.0 or less, and a viscosity is 2.0 mPa·s or more and 20,000 mPa·s or less.

An ink set of the present disclosure includes the above-described treatment liquid composition for dye printing, and a textile printing ink containing an acidic dye and water and/or a textile printing ink containing a reactive dye and water.

A recording method of the present disclosure includes a treatment liquid attachment step of attaching the above-described treatment liquid composition for dye printing to a fabric, and an ink attachment step of attaching a textile printing ink containing an acidic dye and water and/or a textile printing ink containing a reactive dye and water to the fabric.

### BRIEF DESCRIPTION OF THE DRAWINGS

FIG. 1 is a view illustrating an example of a recording apparatus used in a recording method of the present embodiment.

FIG. 2 is a table illustrating examples and comparative examples according to a rotary screen method.

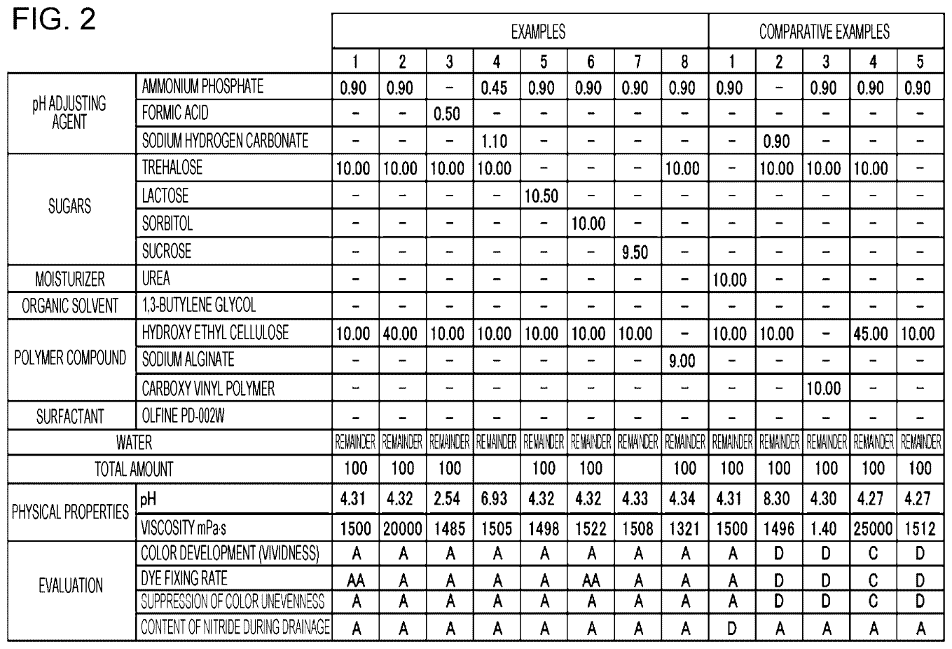

FIG. 3 is a table illustrating examples and comparative examples according to an ink jet method.

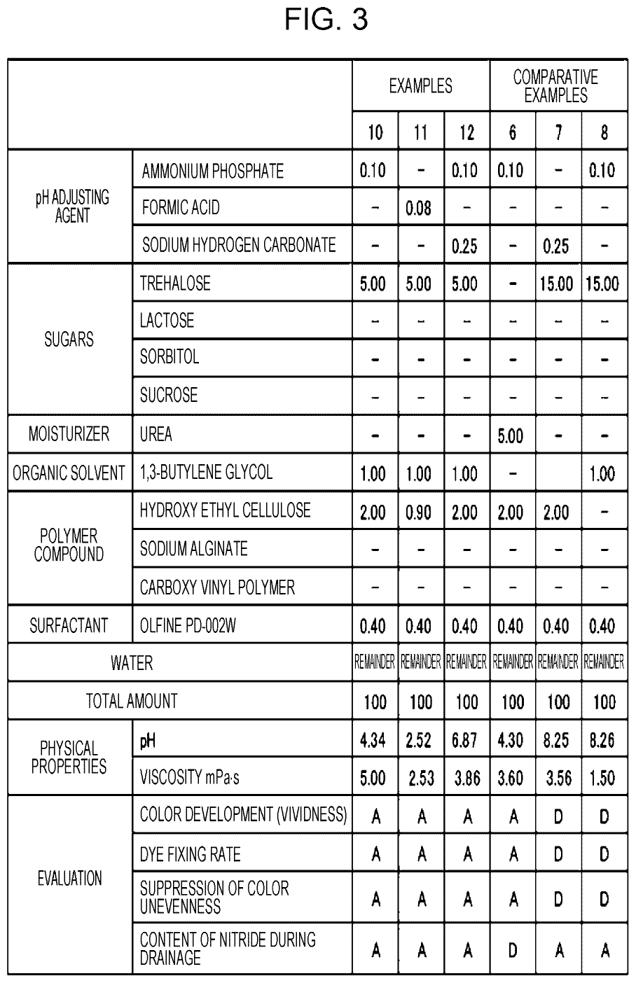

### DESCRIPTION OF EMBODIMENTS

Hereinafter, an embodiment of the present disclosure (hereinafter referred to as “the present embodiment”) is described in detail with reference to the drawings but the present disclosure is not limited thereto and can be variously modified without deviating from the scope of the present disclosure as described in the claims. In the drawings, the same components are designated by the same reference numerals and the same description will be omitted. A positional relationship, such as left, right, top, and bottom, should be based on a positional relationship illustrated in the drawings unless otherwise particularly specified. Furthermore, dimensional ratios in the drawings are not limited to ratios illustrated in the drawings.

### 1. Treatment Liquid Composition for Dye Printing

The treatment liquid composition for dye printing according to the present embodiment (hereinafter, also simply referred to as “treatment liquid composition”) contains one or more types of sugars selected from lactose, sucrose, trehalose, and sorbitol, a polymer compound, and a pH adjusting agent, has a pH of 7.0 or less, and has a viscosity of 2.0 mPa·s or more and 20,000 mPa·s or less.

In dye printing, a treatment liquid composition is applied to a fabric before printing and dyeing are performed in order to enhance a color developing property of the textile printing ink. In such a treatment liquid composition, urea is used in expectation of an effect of dissolving a dye and fixing the dye to the fabric, an effect of equalizing a temperature in a steaming step, and the like. However, when the treatment liquid composition containing urea is used, a large amount of waste liquid containing a nitrogen source such as urea is generated in washing of a printed matter after printing, and environmental adaptability is concerned.

On the other hand, in the treatment liquid composition of the present embodiment, a predetermined sugar is used. As a result, a fixing property and a color developing property of a textile printing ink can be improved, suppression of color unevenness can be achieved due to equalization of the temperature in the steaming step, and a textile printing method in which a nitrogen discharge amount is small and the environmental adaptability is excellent can be provided.

The treatment liquid composition of the present embodiment may be used in combination with an ink jet textile printing ink or may be used in combination with a rotary textile printing ink, and a dye contained in the textile printing ink is not particularly limited. Among these, it is preferable that the treatment liquid composition of the present embodiment is used in combination with a textile printing ink containing an acidic dye and water and/or a textile printing ink containing a reactive dye and water. By using the treatment liquid composition in combination with such a textile printing ink, the fixing property and the color developing property tend to be further improved.

Hereinafter, the treatment liquid composition for dye printing, an ink set, a recording method, and the like according to the present embodiment will be described in detail.

### 1.1. Sugars

The treatment liquid composition of the present embodiment contains one or more types of sugars selected from lactose, sucrose, trehalose, and sorbitol. Among these, trehalose and sorbitol are more preferable. By using such a sugar, the fixing property and the color developing property tend to be further improved.

A mechanism by which the fixing property and the color developing property are improved by using the above-mentioned predetermined sugar is considered as follows. Dyeing occurs when a functional group of the dye and a functional group of fibers of the fabric form a covalent bond or a non-covalent bond. The sugar improves the affinity between the dye and water and improves the solubility of the dye, and thus it is considered that the sugar promotes formation of the covalent bond or the non-covalent bond between the dye and the fabric, and thereby the fixing property and the color developing property are further improved.

In addition, by using the above-mentioned predetermined sugar, color unevenness in a plane can be suppressed. Specifically, the formation of the covalent bond or the non-covalent bond between the dye and the fabric is promoted in a steaming step reaction described later, but the viscosity is improved by using the above-mentioned sugar, so that the color unevenness in a surface direction is suppressed. In addition, it is considered that a variation in an in-plane temperature difference in the steaming step is suppressed and the in-plane color unevenness is suppressed by using the above-described predetermined sugar. For example, in the steaming step, in a portion where the temperature is high or a steam is excessively supplied, the sugar is in a state of being easily reacted with water as compared with the other portions. In this manner, it is considered that a temperature is suppressed by an endothermic reaction between the sugar and water in the portion where the temperature is high or the steam is excessively supplied, and the temperature difference in the in-plane is homogenized.

However, in the treatment liquid composition of the present embodiment, the mechanism for improving the fixing property and the color developing property and the mechanism for suppressing the color unevenness in the in-plane are not limited to the above.

The content of the sugar is preferably 1.0% by mass to 25% by mass with respect to the total amount of the treatment liquid composition, and may be appropriately adjusted according to an application.

Specifically, the content of the sugar in the treatment liquid composition used in combination with an ink jet textile printing ink is preferably 1.0% by mass to 20% by mass, more preferably 2.0% by mass to 15% by mass, still more preferably 3.0% by mass to 10% by mass, and particularly preferably 4.0% by mass to 7.5% by mass with respect to the total amount of the treatment liquid composition. When the content of the sugar is within the above range, in the recording method using an ink jet method, the fixing property and the color developing property tend to be further improved.

The content of the sugar in the treatment liquid composition used in combination with an analog textile printing ink such as a rotary screen method is preferably 2.5% by mass to 25% by mass, more preferably 5.0% by mass to 20% by mass, and still more preferably 7.5% by mass to 15% by mass with respect to the total amount of the treatment liquid composition. When the content of the sugar is within the above range, the fixing property and the color developing property tend to be further improved in the analog textile printing.

### 1.2. Polymer Compound

By including the polymer compound, the viscosity of the treatment liquid composition tends to be further improved, and occurrence of the color unevenness is suppressed.

With regard to the polymer compound, it is preferable that the polymer compound has an action of improving viscosity under acidic conditions of pH 7 or less. As a result, the color unevenness tends to be suppressed. Such a polymer compound is not particularly limited, and examples thereof include one or more types selected from the group consisting of guar gum, tamarind gum, xanthan gum, carboxyethyl cellulose, ammonium cellulose, hydroxyethyl cellulose, sodium alginate, an acrylic polymer, polyethylene glycol, polyacrylamide, an acrylamide copolymer, and dextrin. Among these, hydroxyethyl cellulose and sodium alginate are more preferable.

The content of the polymer compound is preferably 0.1% by mass to 45% by mass with respect to the total amount of the treatment liquid composition, and may be appropriately adjusted according to an application.

Specifically, the content of the polymer compound of the treatment liquid composition used in combination with the ink jet textile printing ink is preferably 0.1% by mass to 25% by mass, more preferably 0.3% by mass to 10% by mass, still more preferably 0.5% by mass to 5.0% by mass, particularly preferably 0.75% by mass to 4.0% by mass, and most preferably 1.0% by mass to 3.0% by mass with respect to the total amount of the treatment liquid composition. When the content of the polymer compound is within the above range, the color unevenness tends to be further suppressed in the recording method using the ink jet method.

The content of the polymer compound of the treatment liquid composition used in combination with the analog textile printing ink is preferably 2.5% by mass to 45% by mass, more preferably 5.0% by mass to 35% by mass, and still more preferably 7.5% by mass to 20% by mass with respect to the total amount of the treatment liquid composition. When the content of the polymer compound is within the above range, the color unevenness tends to be further suppressed in the analog textile printing.

### 1.3. pH Adjusting Agent

By including the pH adjusting agent, a reaction efficiency between the fabric and the dye is further improved, the fixing property and the color developing property are further improved, and the color unevenness is also suppressed. Such a pH adjusting agent is not particularly limited, but it is preferable that the pH adjusting agent makes the treatment liquid composition acidic, and examples thereof include one or more types selected from the group consisting of citric acid, ammonium phosphate, ammonium sulfate, boric acid, lactic acid, boronic acid, maleic acid, malic acid, polyacrylic acid, tartaric acid, ammonium tartrate, ammonium lactate, acetic acid, ammonium acetate, ammonium nitrate, oxalic acid, ammonium oxalate, thiosulfuric acid, ammonium thiosulfate, and formic acid. Among these, ammonium phosphate, boric acid, and formic acid are more preferable.

The content of the pH adjusting agent is preferably 0.01% by mass to 3.0% by mass with respect to the total amount of the treatment liquid composition, and may be appropriately adjusted according to an application.

Specifically, the content of the pH adjusting agent in the treatment liquid composition used in combination with the ink jet textile printing ink is preferably 0.01% by mass to 2.0% by mass, 0.05% by mass to 1.0% by mass, and 0.08% by mass to 0.5% by mass with respect to the total amount of the treatment liquid composition. When the content of the pH adjusting agent is within the above range, in the recording method using the ink jet method, the fixing property and the color developing property tend to be further improved.

The content of the pH adjusting agent in the treatment liquid composition used in combination with the analog textile printing ink is preferably 0.10% by mass to 3.0% by mass, more preferably 0.20% by mass to 2.0% by mass, still more preferably 0.30% by mass to 1.5% by mass, and particularly preferably 0.50% by mass to 1.25% by mass with respect to the total amount of the treatment liquid composition. When the content of the pH adjusting agent is within the above range, the fixing property and the color developing property tend to be further improved in the analog textile printing.

1.4. pH

When the pH exceeds 7, there is a concern that the hydroxyl group contained in the above-mentioned sugar and the functional group contained in the dye react with each other, and the reaction efficiency between the fabric and the dye is lowered. Therefore, in the treatment liquid composition of the present embodiment using the sugar, the pH is 7.0 or less, preferably 6.5 or less, more preferably 6.0 or less, still more preferably 5.5 or less, particularly preferably 5.0 or less, and most preferably 4.5 or less. Since the pH is 7.0 or less, the reaction efficiency between the fabric and the dye tends to be further improved, so that the fixing property and the color developing property are further improved, and the color unevenness also tends to be suppressed. In addition, the pH of the treatment liquid composition is preferably 1.0 or more, more preferably 1.5 or more, still more preferably 2.0 or more, and particularly preferably 2.5 or more. Since the pH is 1.0 or more, handleability is excellent, and a damage to the fabric or the like due to the acid tends to be reduced.

### 1.5. Viscosity

The viscosity of the treatment liquid composition is 2.0 mPa·s or more and 20,000 mPa·s or less, and may be appropriately adjusted according to an application. Note that in the present specification, the viscosity refers to a value measured under conditions of a temperature of 20° C., a rotational speed of 20 rpm, and 60 seconds by using a Brookfield viscometer.

Specifically, the viscosity of the pretreatment liquid composition used in combination with the ink jet textile printing ink is preferably 2.5 mPa·s or more and 100 mPa·s or less, more preferably 3.0 mPa·s or more and 50 mPa·s or less, still more preferably 3.5 mPa·s or more and 25 mPa·s or less, and particularly preferably 4.0 mPa·s or more and 10 mPa·s or less. When the viscosity is 2.5 mPa·s or more, the fixing property and the color developing property tend to be further improved, and bleeding tends to be suppressed. In addition, when the viscosity is 100 mPa·s or less, ejection stability of the treatment liquid composition in the ink jet method tends to be further improved.

In addition, the viscosity of the pretreatment liquid composition used in combination with the analog textile printing ink is preferably 500 mPa·s or more and 20,000 mPa·s or less, more preferably 750 mPa·s or more and 10,000 mPa·s or less, still more preferably 1,000 mPa·s or more and 5,000 mPa·s or less, and particularly preferably 1,250 mPa·s or more and 2, 500 mPa·s or less. When the viscosity is 500 mPa·s or more, the fixing property and the color developing property tend to be further improved, and the bleeding tends to be suppressed. In addition, when the viscosity is 20,000 mPa·s or less, coatability of the treatment liquid composition in the analog textile printing tends to be further improved.

### 1.6. Urea

In the treatment liquid composition for dye printing, urea may contribute to an improvement of the fixing property and the color developing property of the printing ink, but it is necessary to use a large amount of water when removing urea from a printed matter, and thus there is a problem in environmental adaptability such as a waste water treatment.

In the treatment liquid composition of the present embodiment, the above-described specific sugars are included as an alternative to such urea. Therefore, the content of urea is preferably 50 g/kg or less, more preferably 40 g/kg or less, still more preferably 30 g/kg or less, even more preferably 20 g/kg or less, further more preferably 10 g/kg or less, particularly preferably 5 g/kg or less, and most preferably 1 g/kg or less with respect to the total amount of the treatment liquid composition, and urea may not be contained. When the content of urea is 50 g/kg or less, the amount of water used at the time of drainage can be reduced, and the environmental adaptability tends to be further improved.

### 1.7. Water-Soluble Organic Solvent

The treatment liquid composition preferably contains a water-soluble organic solvent. Examples of the water-soluble organic solvent include glycol-based solvents, glycol monoether-based solvents, compounds containing three hydroxyl groups such as glycerin, nitrogen-containing solvents, alcohol-based solvents, and the like. From the viewpoint of improving permeability and the color developing property, it is preferable to include a glycol-based solvent among the water-soluble organic solvents. The water-soluble organic solvents may be used alone or in combination with two or more types.

Specific examples of the glycol-based solvent include 1,3-butylene glycol (1,3-butanediol), ethylene glycol, diethylene glycol, triethylene glycol, propylene glycol, dipropylene glycol, 1,3-propane diol, 1,2-butanediol, 1,2-pentanediol, 1,2-hexanediol, 1,4-butanediol, 1,5-pentanediol, 1,6-hexanediol, and the like. From the viewpoint of more effectively and reliably achieving the effect of the present disclosure, 1,3-butylene glycol (1,3-butanediol) is preferable.

The content of the glycol-based solvent is preferably 0.1% by mass to 5.0% by mass, more preferably 0.5% by mass to 3.0% by mass, and still more preferably 0.7% by mass to 2.0% by mass with respect to the total amount of the treatment liquid composition. When the content of the glycol-based solvent is within the above range, the effect of the present disclosure is further effectively and reliably exhibited.

Examples of solvents other than the glycol-based solvent include ethylene glycol monomethyl ether, ethylene glycol monoethyl ether, triethylene glycol monobutyl ether, and the like as glycol monoether-based solvents, 2-pyrrolidone, N-methyl-2-pyrrolidone, N-ethyl-2-pyrrolidone, and the like as nitrogen-containing solvents, and methanol, ethanol, n-propyl alcohol, iso-propyl alcohol, n-butanol, 2-butanol, tert-butanol, iso-butanol, n-pentanol, and the like as alcohol-based solvents.

The content of the water-soluble organic solvent is preferably 0.1% by mass to 5.0% by mass, 0.5% by mass to 3.0% by mass, or 0.7% by mass to 2.0% by mass with respect to the total amount of the treatment liquid composition. When the content of the water-soluble organic solvent is within the above range, the effect of the present disclosure can be further effectively and reliably exhibited.

### 1.7. Surfactant

The treatment liquid composition may further contain a surfactant. Examples of the surfactant include an acetylene glycol-based surfactant, a fluorine-based surfactant, and a silicone-based surfactant. The surfactant may be used alone or in combination with two or more types.

From the viewpoint of more effectively and reliably achieving the effect of the present disclosure, the treatment liquid composition preferably contains an acetylene glycol-based surfactant. Examples of acetylene glycol-based surfactants include Olfine (registered trademark) B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (manufactured by Nissin Chemical Industry Co., Ltd.), Surfynol (registered trademark) 104, 104E, 104H, 104A, 104BC, 104DPM, 104PA, 104PG-50, 104S, 420, 440, 465, and 485, and Acetylenol (registered trademark) E00, E00P, E40, and E100 (manufactured by Kawaken Fine Chemicals Co., Ltd.). Among these, from the same viewpoint as described above, it is preferable to use PD-002W.

Examples of the silicone-based surfactant include a polysiloxane-based compound such as a polyether-modified organosiloxane. Examples of commercially available polyether-modified organosiloxane include BYK-306, BYK-307, BYK-333, BYK-341, BYK-345, BYK-346, and BYK-348 (manufactured by BYK Chemie Japan KK), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (manufactured by Shin-Etsu Chemical Co., Ltd.).

Examples of the fluorine-based surfactant include a fluorine-modified polymer, and examples thereof include BYK-340 (manufactured by BYK Chemie Japan KK).

The content of the surfactant is preferably 0.01% by mass to 1.5% by mass, more preferably 0.05% by mass to 1.0% by mass, and still more preferably 0.07% by mass to 0.75% by mass with respect to the total amount of the treatment liquid composition. When the content of the surfactant is within the above range, the effect of the present disclosure can be further effectively and reliably exhibited.

### 1.8 Water

The treatment liquid composition includes water. Examples of the water include ion-exchanged water, ultrafiltration water, reverse osmosis water, pure water such as distilled water, and ultrapure water.

The content of water is preferably 60% by mass to 98% by mass with respect to the total amount of the treatment liquid composition, and may be appropriately adjusted according to an application.

Specifically, the content of water in the treatment liquid composition used in combination with the ink jet textile printing ink is preferably 70% by mass to 98% by mass, more preferably 80% by mass to 96% by mass, and still more preferably 85% by mass to 94% by mass with respect to the total amount of the treatment liquid composition. When the content of water is within the above range, ejection stability of the treatment liquid composition in the ink jet method tends to be further improved.

The content of water in the treatment liquid composition used in combination with the analog textile printing ink is preferably 60% by mass to 95% by mass, more preferably 65% by mass to 90% by mass, and still more preferably 70% by mass to 85% by mass with respect to the total amount of the treatment liquid composition. When the content of water is within the above range, the coatability of the treatment liquid composition in the analog textile printing tends to be further improved.

### 1.9. Coloring Material

The treatment liquid composition may contain a coloring material. When the treatment liquid composition contains the coloring material, the fabric can be colored by using the treatment liquid composition in the analog textile printing method. In particular, when liquid flow dyeing is performed as the analog textile printing method, it is preferable that the treatment liquid composition contains the coloring material.

On the other hand, in analog textile printing other than the liquid flow dyeing and in digital textile printing such as an ink jet method, the treatment liquid composition is not used for the purpose of coloring, but is used to improve the fixing property of the textile printing ink, and in that respect, the treatment liquid composition is at least distinguished from the textile printing ink. That is, it is preferable that the treatment liquid composition substantially does not contain the coloring material. More specifically, the content of the coloring material in the treatment liquid composition is preferably 0.18 by mass or less, more preferably 0.05% by mass or less, and still more preferably 0.01% by mass or less with respect to the total amount of the treatment liquid composition. A lower limit of the content of the coloring material is not particularly limited, but is 0% by mass.

### 1.10. Other Components

The treatment liquid composition may further contain components other than those described above as necessary. Such a component is not particularly limited, and examples thereof include a dissolution aid, a viscosity modifier, an antioxidant, a preservative, an antifungal agent, a corrosion inhibitor, a chelating agent and other additives for capturing metal ions that affect dispersion, and a solvent other than the above-mentioned solvent.

The treatment liquid composition of the present embodiment can be prepared by a known method. For example, the treatment liquid composition can be prepared by mixing each component in any order and removing impurities, foreign matter, and the like by performing filtration or the like as necessary. As a method of mixing each of the components, for example, a method of sequentially adding each component into a container equipped with a stirring device such as a mechanical stirrer or a magnetic stirrer, and performing stirring and mixing is used. Examples of the filtration method include centrifugal filtration and filter filtration.

### 1.11. Recording Medium

The recording medium used in the present embodiment is not particularly limited, and may be a fabric, and examples of the fibers constituting the fabric include natural fibers such as cotton, silk, and wool, regenerated fibers such as rayon and cupra, or a blended fabric of these natural fibers and regenerated fibers, a blended fabric of artificial fibers such as polyester fibers, nylon fibers, triacetate fibers, diacetate fibers, and polyamide fibers, and the like.

In addition, it is preferable that the treatment liquid composition of the present embodiment is attached to a fabric having an amide group. The fabric is not particularly limited, but examples thereof include those containing one or more types of fibers selected from the group consisting of silk, wool, nylon, and polyamide elastomer, and those containing one or more types of fibers selected from the group consisting of silk, wool, nylon 6, nylon 6,6, nylon 11, and polyamide elastomer. The fabric may be a blended fabric containing the fibers, or may be, for example, a blended fabric of 80% of nylon and 20% of polyamide elastomer. By using such a recording medium, the fixing property and the color developing property tend to be further improved.

### 2. Ink Set

The ink set of the present embodiment includes the above-mentioned treatment liquid composition for dye printing and a textile printing ink containing an acidic dye and water and/or a textile printing ink containing a reactive dye and water. The ink set of the present embodiment also preferably includes the above-mentioned treatment liquid composition for dye printing and an ink jet textile printing ink containing an acidic dye and water and/or an ink jet textile printing ink containing a reactive dye and water. By using such an ink set, the fixing property and the color developing property are further improved. In the present embodiment, one recording apparatus may be mounted with both the textile printing ink that is an acidic dye and the textile printing ink that is a reactive dye.

Examples of the reactive dye included in the textile printing ink include C. I. Reactive Yellow 3, 6, 12, 18, 86; C. I. Reactive Orange 2, 5, 12, 13, 20; C. I. Reactive Red 3, 4, 7, 12, 13, 15, 16, 24, 29, 31,32, 33, 43, 45, 46, 58, 59; C. I. Reactive Violet 1,2; C. I. Reactive Blue 2, 3, 5, 7, 13, 14, 15, 25, 26, 39, 40, 41, 46, 49, 176; C. I. Reactive Green 5, 8; C. I. Reactive Brown 1, 2, 7, 8, 9, 11, 14; C. I. Reactive Black 1, 2, 3, 8, 10, 12, 13, and the like. Note that in the present specification, the reactive dye refers to a compound classified as a reactive dye in the Color Index.

Note that in the present embodiment, the fabric to which the treatment liquid composition is attached by the ink jet method may be dried and the printing ink may be applied by the ink jet method, or the fabric to which the treatment liquid composition is attached by the analog textile printing such as a rotary screen method may be dried, and the printing ink may be applied by the ink jet method. Alternatively, the printing ink may be applied by the ink jet method to the fabric immersed in the treatment liquid composition and dried. As described above, when the treatment liquid composition is attached and then dried, the viscosity of the treatment liquid composition and the viscosity of the printing ink do not need to match.

The ink that is used is not limited to the ink jet textile printing ink, and may be combined with an ink for analog textile printing such as a rotary screen method.

### 3. Ink Jet Recording Method

The recording method of the present embodiment includes a treatment liquid attachment step of attaching the treatment liquid composition for dye printing described above to a fabric, and an ink attachment step of attaching a textile printing ink containing an acidic dye and water and/or a textile printing ink containing a reactive dye and water to the fabric. The ink jet recording method of the present embodiment also preferably includes a treatment liquid attachment step of attaching the treatment liquid composition for dye printing described above to a fabric, and an ink attachment step of attaching an ink jet textile printing ink containing an acidic dye and water and/or an ink jet textile printing ink containing a reactive dye and water to the fabric by the ink jet method.

### 3.1. Treatment Liquid Attachment Step

The treatment liquid attachment step is a step of attaching the treatment liquid composition to the recording medium. A method of attaching the treatment liquid composition to the fabric is not particularly limited, and for example, the fabric may be immersed in or passed through the treatment liquid composition, or the treatment liquid composition may be applied by the ink jet method. In addition, the method is preferably any of a spray processing method, a padding processing method, a screen method, and a kiss roll method. In addition, the fabric may be dried once before the printing ink is attached after the treatment liquid composition is attached.

In the present embodiment, the “ink jet method” refers to a method of ejecting an ink composition or a treatment liquid from a nozzle in an ink jet head. Examples of such a method include a method of driving a pressure generating unit to eject a composition filled in a pressure generating chamber of the ink jet head from the nozzle, and a method of ejecting the composition by applying thermal energy. The method of applying pressure to the ink composition in the nozzle is not particularly limited, and examples thereof include a piezo method of ejecting droplets of the ink composition by using a piezoelectric element and a thermal method of ejecting droplets by heating.

### 3.2. Ink Attachment Step

An ink attachment step is a step of further attaching the textile printing ink on a portion to which the above-described treatment liquid composition is attached. In the ink attachment step, the textile printing ink is also preferably attached by the ink jet method. When the treatment liquid attachment step and the ink attachment step are performed by the ink jet method, the treatment liquid attachment step and the ink attachment step may be performed in the same pass or in different passes. By performing the treatment liquid attachment step and the ink attachment step on the same pass, productivity of a printed matter tends to be further improved.

### 3.3. Steaming Step

In a steaming step, steam is applied to the fabric to which the textile printing ink is attached by a normal pressure steaming method, a high pressure steaming method, or the like. As a result, fixing of the dye to the fabric is promoted. Steaming conditions are not particularly limited, and examples thereof include conditions of 80° C. to 150° C. for 5 to 20 minutes. Thereafter, a washing step of washing the fabric to remove extra components such as components contained in the treatment liquid composition or the printing ink which are not attached to the fabric, and a drying step of drying the washed printed matter may be performed.

### 4. Ink jet Recording Apparatus

When the treatment liquid composition and the textile printing ink are attached to the recording medium by the ink jet recording apparatus, the ink jet recording apparatus used is not particularly limited, and any of a serial type and a line type can be used.

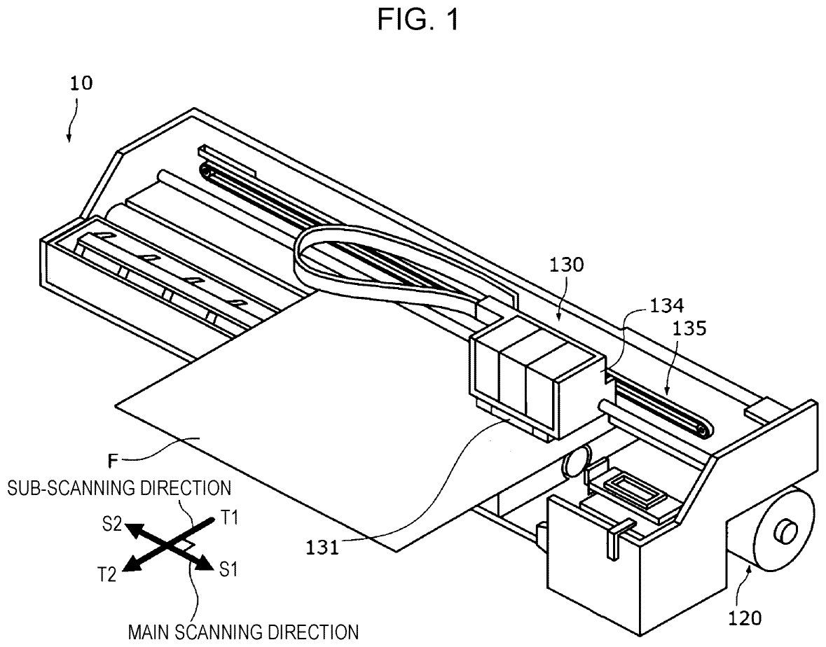

As an example of the ink jet recording apparatus, FIG. 1 shows a perspective view of a serial type recording apparatus. As illustrated in FIG. 1, a serial type recording apparatus 10 includes a transport section 120 and a recording section 130. The transport section 120 transports a recording medium F fed to the serial type recording apparatus to the recording section 130, and discharges the recording medium after recording to the outside of the serial type recording apparatus. Specifically, the transport section 120 includes each feeding roller and transports the fed recording medium F in a sub-scanning direction T1.

In addition, the recording section 130 in the recording apparatus includes a carriage 134 on which an ink jet head 131 including nozzles for ejecting the treatment liquid composition and the textile printing ink onto the recording medium F sent from the transport section 120 is mounted, and a carriage moving mechanism 135 for moving the carriage 134 in main scanning directions S1 and S2 of the recording medium F.

In addition, the recording section 130 in the recording apparatus includes the nozzles for ejecting the treatment liquid composition and the textile printing ink.

In the case of the serial type recording apparatus, a head having a length smaller than a width of a recording medium is provided as the ink jet head 131, the head moves, and recording is performed in a plurality of passes (multi-pass). In the serial type recording apparatus, the head 131 is mounted on the carriage 134 that moves in a predetermined direction, and the head moves with the movement of the carriage to eject the ink composition onto the recording medium. As a result, attachment is performed in two or more passes (multi-pass). The passes are also referred to as main scanning. Sub-scanning in which the recording medium is transported is performed between the passes. That is, the main scanning and the sub-scanning are alternately performed.

### EXAMPLES

Hereinafter, the present disclosure will be described in more detail with reference to Examples and Comparative Examples. The present disclosure is not limited by following Examples.

### 1. Preparation of Treatment Liquid Composition for Textile Printing

A treatment liquid composition for textile printing of each example was obtained by putting respective components into a tank for a mixture so as to have compositions shown in Tables 1 and 2, mixing and stirring the components, and further filtering the components with a membrane filter. Numerical values of each component shown in each example in the tables represent % by mass.

Details of product components used in Tables 1 and 2 are as follows.

### pH Adjusting Agent

Ammonium phosphate
Formic acid
Sodium hydrogen carbonate

### Sugars

Trehalose
Lactose
Sorbitol
Sucrose

### Moisturizer

Urea

### Water-Soluble Organic Solvent

1,3-Butylene glycol

### Polymer Compound

Hydroxyethyl cellulose
Sodium alginate
Carboxy vinyl polymer

### Surfactant

Olfine PD-002W (trade name, acetylene glycol-based surfactant, manufactured by Nisshin Chemical Industry Co., Ltd.)

### 1.1. Method for Measuring Viscosity

A viscosity of the treatment liquid composition prepared as described above was measured under conditions of a temperature of 20° C., a rotational speed of 20 rpm, and 60 seconds by using a BROOKFIELD viscometer.

### 1.2. Method of Measuring pH

A pH of the treatment liquid composition prepared as described above was measured by using a desktop-type pH meter (model: F-72, manufacturer: manufactured by HORIBA). Note that the measurement temperature was set to 20° C.

### 2. Recording Method

### 2.1. Recording Method by Rotary Screen Method

The treatment liquid composition was applied to a nylon fabric and was dried. Then, a screen for each color was set in a printer, and printing was performed on the fabric to which the treatment liquid composition was applied. Specifically, the textile printing ink was supplied into the screen, and the printing ink was transferred to the fabric by rotating the screen to pass through the opening of the screen. As a result, a solid pattern was printed.

Thereafter, the fabric to which the ink was attached was treated under conditions of 10 minutes at 102° C. by using a high-temperature steamer (manufactured by TSUJII SEISAKU-SHO Co., Ltd., “HT-3-550 type”), and then dried. Then, the components such as an extra dye on the fabric were washed away to obtain a printed matter.

As the textile printing ink in the rotary screen method, in Examples 1 to 9 and Comparative Examples 1 to 5, a printed matter using Kayacelon Black C-HK (manufactured by Nippon Kayaku Co., Ltd.) containing a reactive dye was prepared, and in Example 4, a printed matter using Best Acid Blue RL 200% (Orient GIANT DYE & CHIMICAL IND CORP) containing an acidic dye was also prepared. In addition, the printed matter using the acidic dye in Example 4 also had excellent results in each evaluation described below as in the case of using the reactive dye.

### 2.2. Recording Method Using Ink Jet Method

The treatment liquid composition was applied to a nylon fabric and was dried. Each textile printing ink (GENESTA AC/RE) was set in a Monna Lisa ink jet textile printing machine (Monna Lisa Evo Tre 16-180, manufactured by Seiko Epson Corporation), and a solid pattern was printed on a nylon fabric at 900×600 dpi.

Thereafter, the fabric to which the ink was attached was treated under conditions of 10 minutes at 102° C. by using a high-temperature steamer (manufactured by TSUJII SEISAKU-SHO Co., Ltd., “HT-3-550 type”), and then dried. Then, the components such as an extra dye on the fabric were washed away to obtain a printed matter.

As ink jet textile printing ink, in Examples 10 to 12 and Comparative Examples 6 to 8, a printed matter using CYAN GENESTA AC-H 10L (manufactured by Seiko Epson Corporation) containing an acidic dye was prepared, and in Example 12, a printed matter using BLACK GENESTA RE-N 10L (manufactured by Seiko Epson Corporation) containing a reactive dye was also prepared. In Example 12, the printed matter using the reactive dye also had excellent results in each evaluation described below as in the case of using the acidic dye.

### 3. Evaluation Method

### 3.1. Fixing Property

An optical density of the solid pattern of the printed matter obtained by each of the above methods was measured by using a color measuring instrument i1Pro (manufactured by X-Rite Inc.). In Examples 1 to 9 and Comparative Examples 1 to 5 performed by the rotary screen method, the fixing property was evaluated based on relative values of optical densities of Examples 1 to 9 and Comparative Examples 1 to 5 when an optical density of Comparative Example 1 was set to 100. In addition, in Examples 10 to 12 and Comparative Examples 6 to 8 performed by the ink jet method, the fixing property was evaluated based on relative values of optical densities of Examples 10 to 12 and Comparative Examples 6 to 8 when an optical density of Comparative Example 6 was set to 100.

### Evaluation Standards

A: Relative value of optical density is 95 or more and 100 or less
B: Relative value of optical density is 90 or more and less than 95
C: Relative value of optical density is 85 or more and less than 90
D: Relative value of optical density is less than 85

### 3.2. Color Developing Property

A color difference between a color sample of each ink used for forming the solid pattern and the solid pattern of the printed matter obtained by each of the above methods was measured by using a color measuring instrument i1Pro (manufactured by X-Rite Inc.).

### Evaluation Standards

AA: Color difference (ΔE) is less than 0.4
A: Color difference (ΔE) is 0.4 or more and less than 0.8
B: Color difference (ΔE) is 0.8 or more and less than 1.2
C: Color difference (ΔE) is 1.2 or more and less than 2.0
D: Color difference (ΔE) is 2.0 or more

### 3.3. Suppression of Color Unevenness

In the solid pattern of the printed matter obtained by each of the above methods, the optical density at four vertices of a square having a side length of 10 cm was measured by using a color measurement instrument i1Pro (manufactured by X-Rite, Inc.), and color unevenness was evaluated based on the optical density difference at the four points.

### Evaluation Standards

A: Optical density difference is less than 0.8
B: Optical density difference is 0.8 or more and less than 1.2
C: Optical density difference is 1.2 or more and less than 2.0
D: Optical density difference is 2.0 or more

### 3.4. Content of Nitrides in Drainage

The printed matter, which was obtained as described above, before a washing step was washed with water, and the content of an ammonium salt, the content of nitrate, and the content of other nitrides containing urea in the water after washing were quantified. The content of the ammonium salt was quantified by an indophenol method, which is a method for quantifying the content of the ammonium salt by reacting the ammonium salt with phenol under coexistence of hypochlorite according to JISK0102, and developing a color. In addition, the content of nitrate was quantified by a colorimetric determination method using a reaction of nitrate with sulfosalicylic acid obtained by adding sodium salicylate and sulfuric acid according to JISK0400 and the subsequent color development by an alkali treatment. Furthermore, the content of other nitrides containing urea was quantified by decomposing the sample with peroxysulfate and sulfuric acid, and the subsequent colorimetric determination of nitrate according to the above-mentioned JISK0400.

### Evaluation Standards

A: Total content of nitride is 250 ppm or less.
D: Total content of nitride is more than 250 ppm.

### 5. Evaluation Results

Tables 1 and 2 show compositions of the treatment liquids used in each example and the evaluation results. From Tables 1 and 2, it is found that the printed matter obtained by performing recording by using the treatment liquid composition for dye printing containing one or more types of sugars selected from lactose, sucrose, trehalose, and sorbitol, a polymer compound, and a pH adjusting agent, in which the pH is 7.0 or less and the viscosity is 2.0 mPa·s or more and 20,000 mPa·s or less, is excellent in the fixing property and the color developing property, color unevenness is suppressed, and the amount of water used at the time of draining can be reduced because the content of nitrides in waste water can be reduced.

Note that in the above examples, an example using nylon as the fabric was shown, but the same evaluation was performed for silk, wool, and polyamide elastomer, and the same effect was obtained in the examples and the comparative examples.

What is claimed is:

1. A treatment liquid composition for dye printing, containing:
one or more types of sugars selected from lactose, sucrose, trehalose, and sorbitol;
a polymer compound; and
a pH adjusting agent,
wherein a pH is 7.0 or less, and
a viscosity is 2.0 mPa·s or more and 20,000 mPa·s or less.

2. The treatment liquid composition for dye printing according to claim 1,
wherein the polymer compound includes one or more types selected from the group consisting of guar gum, tamarind gum, xanthan gum, carboxyethyl cellulose, ammonium cellulose, hydroxyethyl cellulose, sodium alginate, an acrylic polymer, polyethylene glycol, polyacrylamide, an acrylamide copolymer, and dextrin.

3. The treatment liquid composition for dye printing according to claim 1,
wherein the pH adjusting agent includes one or more types selected from the group consisting of citric acid, ammonium phosphate, ammonium sulfate, boric acid, lactic acid, boronic acid, maleic acid, malic acid, polyacrylic acid, tartaric acid, ammonium tartrate, ammonium lactate, acetic acid, ammonium acetate, ammonium nitrate, oxalic acid, ammonium oxalate, thiosulfuric acid, ammonium thiosulfate, and formic acid.

4. The treatment liquid composition for dye printing according to claim 1,
wherein the treatment liquid composition for dye printing is attached to a fabric having an amide group.

5. The treatment liquid composition for dye printing according to claim 1,
wherein the treatment liquid composition for dye printing is attached to a fabric including one or more types of fibers selected from the group consisting of silk, wool, nylon, and polyamide elastomer.

6. The treatment liquid composition for dye printing according to claim 1,
wherein a content of urea is 50 g/kg or less with respect to a total amount of the treatment liquid composition for dye printing.

7. The treatment liquid composition for dye printing according to claim 1,
wherein the treatment liquid composition for dye printing is used in combination with an ink jet textile printing ink containing an acidic dye and water and/or an ink jet textile printing ink containing a reactive dye and water.

8. The treatment liquid composition for dye printing according to claim 1, further containing:
a coloring material.

9. An ink set comprising:
the treatment liquid composition for dye printing according to claim 1; and
a textile printing ink containing an acidic dye and water and/or a textile printing ink containing a reactive dye and water.

10. A textile printing recording method comprising:
a treatment liquid attachment step of attaching the treatment liquid composition for dye printing according to claim 1 to a fabric; and
an ink attachment step of attaching a textile printing ink containing an acidic dye and water and/or a textile printing ink containing a reactive dye and water to the fabric.

11. The textile printing recording method according to claim 10,
wherein the treatment liquid attachment step is any one of a spray processing method, a padding processing method, a screen method, and a kiss roll method.
